(19) United States
(12) Patent Application Publication
(10) Pub. No.: US 2022/0361521 A1
(43) Pub. Date: Nov. 17, 2022

(54) OLEAGINOUS CONFECTIONARY AND METHOD FOR MANUFACTURING SAME

(71) Applicant: MEIJI CO., LTD., Tokyo (JP)

(72) Inventors: Kazuhiro MUKAIYAMA, Tokyo (JP); Kaoru HIGAKI, Tokyo (JP); Hiroyuki UTSUNOMIYA, Tokyo (JP)

(73) Assignee: MEIJI CO., LTD., Tokyo (JP)

(21) Appl. No.: 17/621,845

(22) PCT Filed: Jun. 24, 2020
(86) PCT No.: PCT/JP2020/024795

§ 371 Date: Dec. 22, 2021

(30) Foreign Application Priority Data
Jun. 25, 2019 (JP) 2019-117834

(51) Int. Cl. A23G 3/40; A23G 3/42; A23G 3/48; A23G 1/36

(52) U.S. Cl. CPC A23G 3/40; A23G 3/42; A23G 3/48; A23G 1/36

(57) ABSTRACT

Provided are an oil or fat based confectionery having the original pleasant flavor of a functional ingredient, and a method for producing the oil or fat based confectionery. The oil or fat based confectionery is an oil or fat based confectionery that includes a functional food containing a functional ingredient having at least one of bitterness and astringency, and an oil or fat having a solid fat content (SFC) of 70% or more at 25° C. and a SFC of less than 15% at 35° C.; has a granularity of 30 μm or less; has a content of the functional food of 8% by mass or more and 40% by mass or less and a content of sucrose of less than 24% by mass with respect to the oil or fat based confectionery as a whole; and contains no milk ingredient.

### TECHNICAL FIELD

The present invention relates to an oil or fat based confectionery and a method for producing the same.

### BACKGROUND ART

Food products blended with coffee abundantly containing a functional ingredient that has bitterness and astringency are known. For example, PTL 1 discloses an edible coffee bar having a solid form that is produced from a coffee liquor prepared by mixing 10 to 75% by mass finely ground coffee and 25 to 90% by mass vegetable fat or cocoa butter.

### CITATION LIST

### Patent Literature

PTL 1: Japanese Unexamined Patent Publication No. 2014-87339

### SUMMARY OF THE INVENTION

### Technical Problem

When coffee, tea, black tea, red wine, black currant polyphenol, or the like, which abundantly contains a functional ingredient having bitterness and astringency, is contained in a high blending amount with respect to a food product, the bitterness and astringency are strong, and the palatability is therefore impaired. The coffee bar of PTL 1 has a taste adjusted by blending it with 24% by mass or more of sugar. In such a way, the bitterness and astringency have been improved by conventionally adding milk or sugar to a food product abundantly containing a functional ingredient. However, there has been a problem that it is difficult to feel the original pleasant flavor of the functional ingredient.

An object of the present invention is to provide an oil or fat based confectionery having the original pleasant flavor of a functional ingredient, and a method for producing the oil or fat based confectionery.

### Solution to Problem

An oil or fat based confectionery according to the present invention is an oil or fat based confectionery that includes a functional food containing a functional ingredient having at least one of bitterness and astringency, and an oil or fat having a solid fat content (SFC) of 70% or more at 25° C. and a SFC of less than 15% at 35° C.; has a granularity of 30 μm or less; has a content of the functional food of 8% by mass or more and 40% by mass or less and a content of sucrose of less than 24% by mass with respect to the oil or fat based confectionery as a whole; and contains no milk ingredient.

A method for producing the oil or fat based confectionery according to the present invention includes a step of mixing and grinding ingredients to obtain a base having a granularity of 30 μm or less, in which the ingredients include a functional food containing a functional ingredient having at least one of bitterness and astringency, and an oil or fat having a solid fat content (SEC) of 70% or more at 25° C. and a SFC of less than 15% at 35° C.; have a content of the functional food of 8% by mass or more and 40% by mass or less and a content of sucrose of less than 24% by mass with respect to the oil or fat based confectionery as a whole; and include no milk ingredient.

### Advantageous Effects of the Invention

According to the present invention, the oil or fat based confectionery has a content of sucrose of less than 24% by mass and contains no milk ingredient, and can thus have the original flavor of a functional ingredient. Furthermore, the oil or fat based confectionery has an average granularity of 30 μm or less, a solid fat content (SFC) of the oil or fat at 25° C. of 70% or more and a SFC at 35° C. of less than 15%, and can therefore reduce the bitterness and astringency. Therefore, according to the present embodiment, it is possible to provide a highly palatable oil or fat based confectionery having the original pleasant flavor of the functional ingredient while reducing bitterness and astringency.

### BRIEF DESCRIPTION OF DRAWINGS

FIG. 1 A graph that illustrates a result of measuring solid fat contents.

### DESCRIPTION OF EMBODIMENTS

### Embodiment

An oil or fat based confectionery of the present embodiment includes a functional food containing a functional ingredient having at least one of bitterness and astringency, and an oil or fat. The functional ingredient is preferably one or more of caffeine and polyphenol. Examples of the polyphenol include anthocyanin, catechin, chlorogenic acid, tannin, curcumin, and isoflavone.

The functional food preferably contains any one or more of coffee, powdered green tea, black tea, wine, and black currant polyphenol. The content of the functional food is 8% by mass or more and 40% by mass or less, and preferably 15% by mass or more and 40% by mass or less in terms of dry weight with respect to the oil or fat based confectionery as a whole.

As the coffee, ground coffee beans obtained by roasting green coffee beans and then grinding the roasted coffee beans can be used. In addition, coffee powder obtained by processing an extract liquid extracted from ground coffee beans using hot water or the like into powder or granule can be used as the coffee. It is preferable to use the above-mentioned ground coffee beans as the coffee. In the coffee, the moisture content is preferably 5% by mass or less, the caffeine content is preferably 0.01% by mass or more and 2.9% by mass or less, and the chlorogenic acid content is preferably 0.60% by mass or more and 29.2% by mass or less. The granularity of ground coffee beans used as an ingredient is preferably 2.5 mm or less, and the granularity of the coffee powder is preferably 74 μm or less. In the following description, the granularity can be a value obtained by arithmetically averaging values measured using a micrometer.

The green tea is produced from the genus Camellia of the family Theaceae (plant of Camellia sinensis (L) O. Kuntze), and refers to green tea produced into a state where an enzyme in tea leaves is deactivated by a method such as steaming or pot frying tea leaves (including some stems), and then the tea leaves are provided for eating and drinking. Specific examples of the green tea include medium-grade green tea (Sencha), deep-steamed green tea (Fukamushi-cha), coarse tea (Bancha), refined green tea (Gyokuro), steamed green tea (Tencha), and powdered green tea (Matcha). The green tea is preferably powdered green tea or tea powder obtained by processing tea leaves into powder. In the green tea, the moisture content is preferably 5% by mass or less, and the total catechin content is preferably 3% by mass or more and 20% by mass or less, and more preferably 3.5% by mass or more and 18% by mass or less. The granularity of the tea powder used as an ingredient is preferably 330 μm or less, and the granularity of powdered green tea is preferably 30 μm or less.

The black tea means generally so-called black tea obtained by completely fermenting tea leaves, and is regardless of production area, variety, grade of tea leaves, and the like. The black tea may be any of, for example, Darjeeling, Assam, Nilgiri, Uva, Dimbula, Nuwara, and others. The black tea is preferably obtained by processing tea leaves into powder. In the black tea, the moisture content is preferably 7% by mass or less, and the total catechin content is preferably 1% by mass or more and 14% by mass or less, and more preferably 1.3% by mass or more and 12.5% by mass or less. The granularity of the black tea used as an ingredient is preferably 80 mesh pass or less, and more preferably 100 mesh pass or less.

As the wine, it is preferable to use a wine powder obtained by drying a mixed liquid obtained by mixing beverage alcohols and fruit liquors such as red wine, white wine, and rose wine obtained by brewing fruit juice. In the wine powder, the moisture content is preferably 4% by mass or less, the total polyphenol content is preferably 0.01% by mass or more and 4.00% by mass or less, and the alcohol content is preferably 30.0±2.0% by mass. The granularity of the wine powder used as an ingredient is preferably 858 μm or less.

As the black currant polyphenol, it is preferable to use a powder obtained by extracting black currant polyphenol from black currant fruit by water extraction and purifying the extract. In the black currant polyphenol powder, the moisture content is preferably 5% by mass or less, and the total anthocyanin content is preferably 10% by mass or more. The granularity of the black currant polyphenol powder used as an ingredient is preferably 535 μm or less.

When the functional food contains the coffee, the blending amount of the coffee is preferably 15% by mass or more in terms of dry weight with respect to the oil or fat based confectionery as a whole. When the functional food contains the green tea, the blending amount of the green tea is preferably 8% by mass or more in terms of dry weight with respect to the oil or fat based confectionery as a whole. When the functional food contains the black tea, the blending amount of the black tea is preferably 15% by mass or more in terms of dry weight with respect to the oil or fat based confectionery as a whole. When the functional food contains the wine, the blending amount of the wine is preferably 9% by mass or more in terms of dry weight with respect to the oil or fat based confectionery as a whole. When the functional food contains the black currant polyphenol, the blending amount of the black currant polyphenol is preferably 6% by mass or more in terms of dry weight with respect to the oil or fat based confectionery as a whole.

The oil or fat has a solid fat content (SFC) of 70% or more at 25° C. and an SFC of less than 15% at 35° C. The SFC can be measured according to a Standard Methods for the Analysis of

Fats, Oils and Related Materials (2.2.9-2013 Solid fat content (NMR method, established by Japan Oil Chemists' Society)). In the present embodiment, the oil or fat is one or more selected from cocoa butter and commercially available cocoa butter alternatives, and is preferably contained in an amount of 35% by mass or more with respect to the oil or fat based confectionery as a whole.

The oil or fat based confectionery of the present embodiment may be, for example, chocolate such as white chocolate, milk chocolate, or sweet chocolate, and is not limited to chocolate and quasi-chocolate defined in “Fair Competition Code on Representations of Chocolates” as a rule approved by Japan Fair Trade Commission, but can be any type of an oil or fat based confectionery such as fat cream and nut cream of temper type and non-temper type, which do not correspond to the chocolate and quasi-chocolate. In the present embodiment, the oil or fat based confectionery is preferably chocolate.

The oil or fat based confectionery can be combined with foodstuffs such as powdered fruits and vegetables, beans (almond, hazelnut, sesame, etc.), cereals (rice, wheat, etc.), dried fruits (raisins, oranges, etc.), and baked confectioneries (cookies, biscuits, etc.).

The oil or fat based confectionery does not contain a milk ingredient having an effect of masking bitterness or a harsh taste of the functional ingredient. The milk ingredient refers to a component derived from milk and milk itself. Examples of the milk ingredient include whole milk powder, skimmed milk powder, butter milk powder, whey, whey powder, casein, sodium caseinate, lactalbumin, and the like.

The oil or fat based confectionery may be blended with sucrose (sugar), but in the case of the present embodiment, the palatability can be enhanced while moderating astringency and bitterness even if sucrose is not contained. The content of sucrose with respect to the oil or fat based confectionery as a whole is less than 24% by mass, preferably less than 22% by mass, more preferably less than 20% by mass, and still more preferably less than 10% by mass.

When sucrose has a sweetness of 1, the oil or fat based confectionery may contain 25% by mass or more and 45% by mass or less of a low sweetness saccharide having a sweetness of 0.8 or less. The “sweetness” means the sweetness based on the sweetness of sucrose, and can be determined by comparison with the concentration of a test sample exhibiting the same intensity of sweetness as a sucrose solution at a certain concentration by a sensory test using a panel. For example, a saccharide that exhibits the same intensity of sweetness as that of a sucrose solution at a concentration 10 times that of the sucrose solution has a sweetness of 0.1.

Examples of the low sweetness saccharide include fructo-oligosaccharide (sweetness of 0.3), inulin (sweetness of 0.2 or less), maltitol (sweetness of 0.75), glucose (sweetness of 0.64 to 0.74), maltose (sweetness of 0.4), maltotriose (sweetness of 0.3), maltotetraose (sweetness of 0.2), maltopentaose (sweetness of 0.15), isomaltose (sweetness of 0.4), trehalose (sweetness of 0.45), sorbitol (sweetness of 0.6), mannitol (sweetness of 0.5), lactitol (sweetness of 0.35), reduced isomaltulose (sweetness of 0.45), isomaltulose (sweetness of 0.42), erythritol (sweetness of 0.75), and the like, and one or more of these can be used. For example, fructo-oligosaccharide is indigestible oligosaccharide, in which 0.1 to 3 fructose molecules are bonded to a sucrose molecule, is contained in vegetables such as asparagus, garlic, burdock, and onion, and also in honey, and is known to have excellent physiological activity of intestinal regulation action and mineral absorption promoting action. Inulin is a non-digestible polysaccharide, a dietary fiber that can be used by enterobacteria, and a polymer of fructose that is contained in a large amount in asteraceae plants such as burdock and Jerusalem artichoke, and is known for imparting an action of reducing neutral fat in blood and an effect of suppressing an increase in blood glucose level after a meal. Maltitol is a sugar alcohol obtained by hydrogenating maltose at a high pressure to reduce a carbonyl group, has ½ of the calorie of sucrose, and is known as a low-calorie sweetener.

In the oil or fat based confectionery, all saccharide used as an ingredient may be a low sweetness saccharide, or a part of the saccharide may be a low sweetness saccharide. The ratio of the low sweetness saccharide to total saccharides contained as ingredients may be 0% by mass or more and 100% by mass or less, and is preferably 25% by mass or more and 100% by mass or less.

In addition to the above-described ingredients, the oil or fat based confectionery of the present embodiment can be further blended with ingredients used for ordinary oil or fat based confectioneries, such as cacao mass, cocoa powder, vegetable oil or fat, emulsifier, flavor, and colorant, in the range where the effect of the present invention is not impaired. Examples of the vegetable oil or fat include shortening, margarine, rapeseed oil, soybean oil, corn oil, olive oil, palm oil, peanut oil, rice oil, cottonseed oil, sunflower oil, shea butter, safflower oil, coconut oil, palm kernel oil, sesame oil, and the like. Examples of the emulsifier include sucrose fatty acid ester, polyglycerol fatty acid ester, polyglycerol condensed ricinoleic acid ester, and the like. Examples of the flavor include vanillin, vanilla extract, and the like.

The oil or fat based confectionery of the present embodiment can be produced through a mixing step of mixing the above-described ingredients by a conventional method to obtain a first base, a grinding step of further grinding the first base to obtain a second base, and a molding step of molding the second base as necessary.

In the mixing step, the ingredients are mixed using a mixer or the like until the mixture have a uniform appearance. The granularity of the ingredients is not particularly limited as long as it is easy to uniformly mix. The method for producing the oil or fat based confectionery is not limited to the case of adding a functional food as an ingredient and mixing the mixture in the mixing step, and a functional food may be added to and mixed with the second base after the grinding step.

In the grinding step, the first base is ground by means such as roll grinding to obtain a second base having an average granularity of 30 μm or less, preferably 25 μm or less, and more preferably 20 μm or less. The larger the granularity is, the stronger the bitterness is felt. The granularity of the second base can be a value obtained by arithmetically averaging values measured using a micrometer. In the molding step, the second base is filled into a mold and cooled at a predetermined temperature. When molded as mentioned above, the oil or fat based confectionery can be produced by demolding.

The oil or fat based confectionery of the present embodiment includes the functional food containing the functional ingredient having at least one of bitterness and astringency, and the oil or fat having a solid fat content (SFC) of 70% or more at 25° C. and a SFC of less than 15% at 35° C.; has a granularity of 30 μm or less; has a content of the functional food of h by mass or more and 40% by mass or less and a content of sucrose of less than 24% by mass with respect to the oil or fat based confectionery as a whole; and contains no milk ingredient. The oil or fat based confectionery can therefore have the original pleasant flavor of the functional ingredient while reducing the bitterness and the astringency, and can enhance the palatability.

### Modified Example

The present invention is not limited to the above embodiment, and can be appropriately changed within the scope of the gist of the present invention.

### First Examples

Oil or fat based confectioneries were actually produced, and the original flavor of functional ingredients was verified.

### Examples 1 and 2

First, ingredients shown in Table 1 were mixed using a vertical mixer until the mixture had a uniform appearance to obtain a first base (mixing step). For coffee as an ingredient, ground coffee beans having a granularity of 2.38 mm were used. The ground coffee beans had a moisture content of 5% by mass or less, a caffeine content of 0.01% by mass to 2.9% by mass, and a chlorogenic acid content of 0.60% by mass to 29.2% by mass, and the same ground coffee beans were used in each Example. Next, the first base was further ground by a ball mill having a jacket for indirect heating to obtain a second base (grinding step). The conditions of the grinding step were a jacket temperature of 40° C., a rotation speed of 200 rpm, and a grinding time of 1 hour. Subsequently, the second base was filled into a mold, cooled and solidified, and then demolded to obtain an oil or fat based confectionery with coffee according to Example 1 or 2.

Oil or fat based confectioneries with coffee according to Comparative Examples were produced in the same manner as in Examples except that the grinding step was not performed. That is, a first base composed of the ingredients of Example 1 was filled into a mold, cooled and solidified, and then demolded to obtain an oil or fat based confectionery with coffee according to Comparative Example 1; a first base composed of the ingredients of Example 2 was filled into a mold, cooled and solidified, and then demolded to obtain an oil or fat based confectionery with coffee according to Comparative Example 2.

### Examples 3 and 4

First, ingredients other than tea powder shown in Table 1 were mixed using a vertical mixer until the mixture had a uniform appearance to obtain a first base (mixing step). Next, the first base was further ground by a ball mill to obtain a second base (grinding step). The conditions of the grinding step were a jacket temperature of 40° C., a rotation speed of 200 rpm, and a grinding time of 1 hour. Subsequently, the tea powder was ground and mixed with the second base with a food processor until the mixture had a uniform appearance (second grinding step). The tea powder had a granularity of 323 μm or less. The tea powder had a moisture content of 5% by mass or less and a total catechin content of 3% by mass or more and 20% by mass or less, and the same tea powder was used in each Example. The second base mixed with the tea powder was filled into a mold, cooled and solidified, and then demolded to obtain an oil or fat based confectionery with tea powder according to Example 3 or 4.

Oil or fat based confectioneries with tea powder according to Comparative Examples were produced in the same manner as in Examples except that the grinding step was not performed. That is, the tea powder was mixed with a first base composed of ingredients of Example 3, and the first base mixed with the tea powder was filled into a mold, cooled and solidified, and then demolded to obtain an oil or fat based confectionery with tea powder according to Comparative Example 3; the tea powder was mixed with a first base composed of ingredients of Example 4, and the first base mixed with the tea powder was filled into a mold, cooled and solidified, and then demolded to obtain an oil or fat based confectionery with tea powder according to Comparative Example 4.

### Example 5

A chocolate base was prepared by a conventional method using ingredients other than coffee shown in Table 1 (average granularity of 16 μm). Coffee was added to the chocolate base, which was then mixed using a vertical mixer until the mixture had a uniform appearance to obtain a first base (mixing step). For coffee as an ingredient, ground beans having a granularity of 2.38 mm were used. Next, the first base was further ground by a ball mill to obtain a second base (grinding step). The conditions of the grinding step were a jacket temperature of 40° C., a rotation speed of 200 rpm, and a grinding time of 1 hour. Subsequently, the second base was filled into a mold, cooled and solidified, and then demolded to obtain an oil or fat based confectionery with coffee according to Example 5.

With respect to example 5, the first base was filled into a mold without undergoing the grinding step, cooled and solidified, and then demolded to obtain an oil or fat based confectionery with coffee according to Comparative Example 5.

### Example 6

Powdered green tea (granularity of 30 μm or less) was added to the chocolate base of Example 5, which was then mixed using a vertical mixer until the mixture had a uniform appearance to obtain a first base (mixing step), and then the first base was further mixed with a food processor to obtain a second base (grinding step). Subsequently, the second base was filled into a mold, cooled and solidified, and then demolded to obtain an oil or fat based confectionery with powdered green tea according to Example 6. The powdered green tea used had a water content of 5% by mass or less and a total catechin content of 3% by mass or more and 20% by mass or less.

With respect to example 6, the first base was filled into a mold without undergoing a grinding step, cooled and solidified, and then demolded to obtain an oil or fat based confectionery with powdered green tea according to Comparative Example 6.

### Examples 7 to 10

Ingredients shown in Table 1 were mixed using a vertical mixer until the mixture had a uniform appearance to obtain a first base (mixing step). The black tea as an ingredient had a granularity of 154 μm or less. The black tea used had a moisture content of 7% by mass or less and a total catechin content of 1% by mass or more and 14% by mass or less. The wine powder had a granularity of 8.58 μm or less. The wine powder had a moisture content of 4% by mass or less, a total polyphenol content of 0.01% by mass or more and 4.00% by mass or less, and an alcohol content of 30.0±2.0% by mass, and the same wine powder was used in each Example. The black currant polyphenol powder had a granularity of 535 μm or less. The black currant polyphenol powder had a moisture content of 5% by mass or less and a total anthocyanin content of 10V by mass or more, and the same black currant polyphenol powder was used in each Example. Next, the first base was further ground by a ball mill to obtain a second base (grinding step). The conditions of the grinding step were a jacket temperature of 40° C., a rotation speed of 200 rpm, and a grinding time of 1 hour. Subsequently, the second base was filled into a mold, cooled and solidified, and then demolded to obtain an oil or fat based confectionery with black tea according to Example 7, an oil or fat based confectionery with wine according to Example 8, an oil or fat based confectionery with black currant polyphenol according to Example 9, or an oil or fat based confectionery with wine and black currant polyphenol according to Example 10.

Oil or fat based confectioneries according to Comparative Examples were produced in the same manner as in Examples except that the grinding step was not performed. That is, first bases that are composed of the ingredients of Examples 7 to 10 respectively were filled into a mold, cooled and solidified, and then demolded to obtain an oil or fat based confectionery with black tea according to Comparative Example 7, an oil or fat based confectionery with wine according to Comparative Example 8, an oil or fat based confectionery with black currant polyphenol according to Comparative Example 9, and an oil or fat based confectionery with wine and black currant polyphenol according to Comparative Example 10.

TABLE 1

| | | Functional food | | | | | | Oil or fat | | Saccharide with a sweetness |
|---|---|---|---|---|---|---|---|---|---|---|
| | | | Tea | Powdered | Black | Wine | Black | Cocoa | Cacao | of 0.8 or less |
| | | Coffee | powder | green tea | tea | powder | currant | butter | mass | Fructo- |
| | | (% by | (% by | (% by | (% by | (% by | polyphenol | (% by | (% by | oligosaccharide |
| | | mass) | mass) | mass) | mass) | mass) | (% by mass) | mass) | mass) | (% by mass) |
| Example | 1 | 36.0 | | | | | | 35.9 | | 26.1 |
| | 2 | 33.3 | | | | | | 35.1 | | |
| | 3 | | 19.8 | | | | | 35.0 | | 40.0 |
| | 4 | | 15.0 | | | | | 35.0 | | |
| | 5 | 15.0 | | | | | | 2.4 | 54.5 | |
| | 6 | | | 8.0 | | | | 2.6 | 59.0 | |
| | 7 | | | | 15.0 | | | 35.0 | | |
| | 8 | | | | | 15.0 | | 35.0 | | |
| | 9 | | | | | | 15.0 | 35.0 | | |
| | 10 | | | | | 9.0 | 6.0 | 35.0 | | |
| Comparative | 1 | 36.0 | | | | | | 35.9 | | 26.1 |
| example | 2 | 33.3 | | | | | | 35.1 | | |
| | 3 | | 19.8 | | | | | 35.0 | | 40.0 |
| | 4 | | 15.0 | | | | | 35.0 | | |
| | 5 | 15.0 | | | | | | 2.4 | 54.5 | |
| | 6 | | | 8.0 | | | | 2.6 | 59.0 | |
| | 7 | | | | 15.0 | | | 35.0 | | |
| | 8 | | | | | 15.0 | | 35.0 | | |
| | 9 | | | | | | 15.0 | 35.0 | | |
| | 10 | | | | | 9.0 | 6.0 | 35.0 | | |

| | | Saccharide with a sweetness | | | | | | | | |
|---|---|---|---|---|---|---|---|---|---|---|
| | | of 0.8 or less | | | Vegetable | | Cocoa | | | |
| | | Inulin | Maltitol | Sugar | oil or fat | | powder | Flavor | Total | |
| | | (% by | (% by | (% by | (% by | Emulsifier | (% by | (% by | (% by | Granularity |
| | | mass) | mass) | mass) | mass) | (% by mass) | mass) | mass) | mass) | (μm) |
| Example | 1 | | | | 1.8 | 0.2 | | | 100 | 19 |
| | 2 | 30.4 | | | 1.0 | 0.2 | | | 100 | 18 |
| | 3 | | | | 5.0 | 0.2 | | | 100 | 20 |
| | 4 | 45.0 | | | 4.8 | 0.2 | | | 100 | 19 |
| | 5 | | | 21.4 | | 0.7 | 5.9 | 0.2 | 100 | 20 |
| | 6 | | | 23.2 | | 0.7 | 6.3 | 0.2 | 100 | 19 |
| | 7 | 45.0 | | | 4.8 | 0.2 | | | 100 | 20 |
| | 8 | | 45.0 | | 4.8 | 0.2 | | | 100 | 20 |
| | 9 | | 45.0 | | 4.6 | 0.2 | | | 100 | 17 |
| | 10 | | 45.0 | | 4.0 | 0.2 | | | 100 | 19 |
| Comparative | 1 | | | | 1.8 | 0.2 | | | 100 | 250 |
| example | 2 | 30.4 | | | 1.0 | 0.2 | | | 100 | 218 |
| | 3 | | | | 5.0 | 0.2 | | | 100 | 288 |
| | 4 | 45.0 | | | 4.8 | 0.2 | | | 100 | 214 |
| | 5 | | | 21.4 | | 0.7 | 5.9 | 0.2 | 100 | 193 |
| | 6 | | | 23.2 | | 0.7 | 6.3 | 0.2 | 100 | 56 |
| | 7 | 45.0 | | | 4.8 | 0.2 | | | 100 | 63 |
| | 8 | | 45.0 | | 4.8 | 0.2 | | | 100 | 77 |
| | 9 | | 45.0 | | 4.8 | 0.2 | | | 100 | 68 |
| | 10 | | 45.0 | | 4.8 | 0.2 | | | 100 | 74 |

### <Evaluation Method>

For the oil or fat based confectioneries according to Examples and Comparative Examples, the granularity was measured with a micrometer. Furthermore, visual evaluation for the appearance and sensory evaluation by 10 panels trained for taste in the mouth were performed. The score was 3 points in the case of “particularly pleasant”, 2 points in the case of “pleasant”, 1 point in the case of “somewhat unpleasant”, or 0 points in the case of “unpleasant”, and the results are shown in Table 2.

TABLE 2

| | | Sensory evaluation | | Appearance | | |
|---|---|---|---|---|---|---|
| | | Evaluation | | Evaluation | | Comprehensive |
| | | point | Remark | point | Remark | evaluation |
| Example | 1 | 3 | | 3 | | 3 |
| | 2 | 3 | | 3 | | 3 |
| | 3 | 3 | | 3 | | 3 |
| | 4 | 3 | | 3 | | 3 |
| | 5 | 3 | | 3 | | 3 |
| | 6 | 3 | | 3 | | 3 |
| | 7 | 3 | | 3 | | 3 |
| | 8 | 3 | | 3 | | 3 |
| | 9 | 3 | | 3 | | 3 |
| | 10 | 3 | | 3 | | 3 |
| Comparative | 1 | 0 | Significant gritty | 0 | Granular pattern | 0 |
| example | | | texture is felt | | is seen | |
| | 2 | 0 | Significant gritty | 0 | Granular pattern | 0 |
| | | | texture is felt | | is seen | |
| | 3 | 0 | Significant gritty | 2 | | 1 |
| | | | texture is felt | | | |
| | 4 | 0 | Significant gritty | 2 | | 1 |
| | | | texture is felt | | | |
| | 5 | 0 | Significant gritty | 0 | Granular pattern | 0 |
| | | | texture is felt | | is seen | |
| | 6 | 1 | Gritty texture and | 2 | Granular pattern | 1 |
| | | | stickiness are felt | | is seen | |
| | 7 | 1 | Gritty texture and | 2 | Granular pattern | 1 |
| | | | stickiness are felt | | is seen | |
| | 8 | 1 | Gritty texture | 2 | Granular pattern | 1 |
| | | | is felt | | is seen | |
| | 9 | 1 | Gritty texture | 2 | Granular pattern | 1 |
| | | | is felt | | is seen | |
| | 10 | 1 | Gritty texture | 2 | Granular pattern | |
| | | | is felt | | is seen | |

### <Evaluation Results>

In Examples 1 to 10 produced through roll grinding, the oil or fat based confectioneries, which each had a granularity of 20 μm or less, were superior in both sensory evaluation and appearance to Comparative Examples 1 to 10 produced in the same blend but without roll grinding. It was therefore confirmed that, for the oil or fat based confectioneries according to above Examples, the original flavor of each functional ingredient can be obtained. In Comparative Examples in which oil or fat based confectioneries had a large granularity, there were a plurality of evaluations that bitterness was strongly felt.

### Second Examples

Oil or fat based confectioneries that contain different oils or fats were compared for the original flavor of a functional ingredient. As shown in Table 3, ingredients for oil or fat based confectioneries with powdered green tea were prepared. The oils or fats for ingredients were four types including cocoa butter, low-melting-point oil or fat 1, low-melting-point oil or fat 2, and high-melting-point oil or fat. All the ingredients other than the oils or fats were used in the same composition. The granularity of the powdered green tea was 30 μm or less.

The ingredients other than the powdered green tea shown in Table 3 were mixed using a vertical mixer until the mixture had a uniform appearance to obtain a first base (mixing step). Next, the first base was further ground with a refiner to obtain a second base (grinding step). Subsequently, the powdered green tea was mixed with the second base until the mixture had a uniform appearance. The granularity at this time was 20 μm. The base was filled into a mold, cooled and solidified at 10° C., and then demolded. Oil or fat based confectioneries with powdered green tea according to Example 11 and Comparative Examples 11 to 13, which had different oils or fats, were obtained as described above.

TABLE 3

| | | | | Low- | Low- | High- | | | |
|---|---|---|---|---|---|---|---|---|---|
| | | | | melting- | melting- | melting- | | | |
| | | | Cocoa | point oil | point oil | point oil | | Powdered | |
| | Fructo- | Theanins | butter | or fat 1 | or fat 2 | or fat | Emulsifier | green tea | Total |
| | oligosaccharide | (% by | (% by | (% by | (% by | (% by | (% by | (% by | (% by |
| | (% by mass) | mass) | mass) | mass) | mass) | mass) | mass) | mass) | mass) |
| Example 11 | 28.8 | 0.8 | 40.2 | | | | 0.2 | 30.0 | 100 |
| Comparative | 28.8 | 0.8 | | 40.2 | | | 0.2 | 30.0 | 100 |
| example 11 | | | | | | | | | |
| Comparative | 28.8 | 0.8 | | | 40.2 | | 0.2 | 30.0 | 100 |
| example 12 | | | | | | | | | |
| Comparative | 28.8 | 0.8 | | | | 40.2 | 0.2 | 30.0 | 100 |
| example 13 | | | | | | | | | |

### <Measurement of Solid Fat Content>

The SFC of the obtained oil or fat based confectioneries with powdered green tea were measured. First, the samples were each heated in a thermostatic bath at 70° C., homogenized, and placed in a test tube to which a rubber stopper was then attached. The samples each packed in a test tube and a control sample (pharmacopoeia grade olive oil) were held at 60° C. for 30 minutes, and then NMR signals of the samples were each specified. The samples were held at 0° C. for 30 minutes, and then further transferred to 26° C. and held for 30 minutes. Subsequently, the samples were transferred to 0° C. and held for 30 minutes, and then held at a measurement temperature (T° C.) for 30 minutes, and then NMR signals of the samples were each specified. The solid fat content at T ° C. was calculated by the following formula.

Solid fat content (%)=100−(A/B)×(C/D)×100

A: Reading of NMR signal of control sample at 60° C.

B: Reading of NMR signal of measurement sample at 60° C.

C: Reading of NMR signal of control sample at T° C.

D: Reading of NMR signal of measurement sample at T° C.

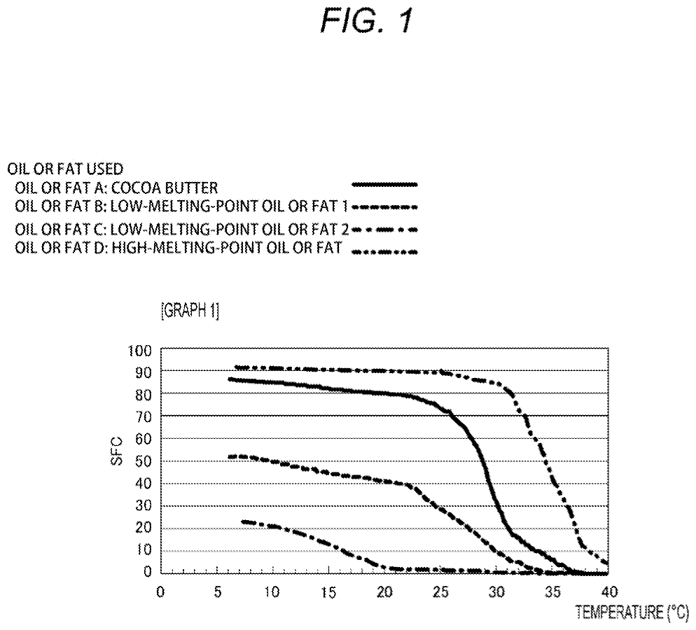

The results are shown in FIG. 1. In FIG. 1, the vertical axis represents SFC, and the horizontal axis represents temperature (° C.). Oils or fats contained in oil or fat based confectioneries with powdered green tea had the following SFCs, respectively.
Cocoa butter (Example 11, oil or fat A in the FIGURE), 74% at 25° C., 7% at 35° C.
Low-melting-point oil or fat 1 (Comparative Example 11, oil or fat B in the FIGURE), 28% at 25° C., 0.1% at 35° C.
Low-melting-point oil or fat 2 (Comparative Example 12, oil or fat C in the FIGURE), 2% at 25° C., 0.1% at 35° C.
High-melting-point oil or fat (Comparative Example 13, oil or fat D in the FIGURE), 89% at 25° C., 44% at 35° C.

### <Evaluation>

The oil or fat based confectioneries with powdered green tea produced were evaluated for four items of “cooling and solidification”, “demolding”, “stirred state at 30° C.”, and “sensory evaluation”. Regarding the “cooling and solidification”, a solidification time at 10° C. was measured, and the cooling and solidification was rated 0 points for the sample that did not solidify, 1 point for the sample that solidified but caused bloom, 2 points for the sample that solidified within a cooling time of more than 2 hours and 24 hours, 3 points for the sample that solidified within a cooling time of more than 60 minutes and 2 hours, 4 points for the sample that solidified within a cooling time of more than 30 minutes and 60 minutes, and 5 points for the sample that solidified without problems within a cooling time of 30 minutes.

The “demolding” was rated 0 points for the sample that could not be demolded, 1 point for the sample that could be demolded but had a percentage of the shapeless part of more than 60% by visual observation, 2 points for the sample that could be demolded but had a percentage of the shapeless part of 60% or less and more than 40% by visual observation, 3 points for the sample that could be demolded but had a percentage of the shapeless part of 40% or less and more than 20% by visual observation, 4 points for the sample that could be demolded but had a percentage of the shapeless part of 20% or less by visual observation, and 5 points for the sample that could be demolded without losing its shape.

The “stirred state at 30° C.” was rated 0 points for the sample that could not be stirred, 1 point for the sample that had a percentage of solid-liquid separation of more than 60% by visual observation, 2 points for the sample that had a percentage of solid-liquid separation of 60% or less and more than 40% by visual observation, 3 points for the sample that had a percentage of solid-liquid separation of 40% or less and more than 20% by visual observation, 4 points for the sample that had a percentage of solid-liquid separation of 20% or less by visual observation, and 5 points for the sample that could be uniformly mixed.

The “sensory evaluation” was performed by trained 10 panels, and was rated 0 points in the case where bitterness and astringency were felt in the aftertaste, 2 points in the case where bitterness and astringency were felt as a whole, and 3 points in the case where the blue taste was refreshing and bitterness and astringency were hard to be felt. The results are shown in Table 4.

TABLE 4

| | | Cooling and | | | | | | Sensory | | |
|---|---|---|---|---|---|---|---|---|---|---|
| | | solidification | | | | | | evaluation | | |
| | | (solidification | | | | Stirred state | | (bitterness and | | |
| | | time at 10° C.) | | Demolding | | at 30° C. | | astringency) | | |
| | | Evaluation | | Evaluation | | Evaluation | | Evaluation | | Comprehensive |
| | | point | Remark | point | Remark | point | Remark | point | Remark | evaluation |
| Example | 11 | 5 | Solidified | 5 | Peelable | 5 | Able to mix | 3 | Refreshing | 4 |
| | | | in 30 min | | without losing | | uniformly | | aftertaste, | |
| | | | (shrunk) | | shape | | | | hard to feel | |
| | | | | | | | | | bitterness | |
| | | | | | | | | | and astringency | |
| Comparative | 11 | 0 | Unable to | 0 | Unable to | 5 | Able to mix | 3 | Refreshing | 2 |
| example | | | solidify even | | demold, lost | | uniformly | | aftertaste, | |
| | | | after 24 h | | shape | | | | hard to feel | |
| | | | | | | | | | bitterness | |
| | | | | | | | | | and astringency | |
| | 12 | 0 | Unable to | 0 | Unable to | 5 | Able to mix | 2 | Feel a little | 1 |
| | | | solidify even | | demold, lost | | uniformly | | bitterness and | |
| | | | after 24 h | | shape | | | | astringency as | |
| | | | | | | | | | a whole | |
| | 13 | 1 | Solidified in 5 | 1 | Lost shape | — | Solidified and | 1 | Feel bitterness | 0 |
| | | | min but caused | | | | unable to stir | | end astringency | |
| | | | bloom | | | | and mix | | in aftertaste | |

### <Evaluation Results>

Based on the oil or fat based confectionery with powdered green tea of Example 11 containing cocoa butter as an oil or fat, oil or fat D (high-melting-point oil or fat) having a high SFC in the temperature zone in the mouth remained undissolved in the mouth, and therefore bitterness and astringency were strongly felt. For oil or fat B (low-melting-point oil or fat 1) having a large inclination in the SFC curve around 25° C. as with the cocoa butter, bitterness and astringency tended to be less felt, which is slightly inferior to the cocoa butter, though. The aftertaste was also relatively good. For oil or fat C (low-melting-point oil or fat 2) having a low SFC in the temperature zone in the mouth, which was dissolved in any temperature zone from the time of being taken in the mouth to the time of being swallowed, bitterness and astringency were felt as a whole.

From the above results, it is considered that the effect of suppressing bitterness and astringency is exhibited in the case where the functional ingredient is not simply coated with an oil or fat, but the oil or fat based confectionery is blended with a specific oil or fat, and the properties of the oil or fat substantially control the physical properties of the blended confectionery.

1. An oil or fat based confectionery comprising:
a functional food containing a functional ingredient having at least one of bitterness and astringency; and
an oil or fat having a solid fat content (SFC) of 70% or more at 25° C. and a SFC of less than 15% at 35° C.,
the oil or fat based confectionery having a granularity of 30 μm or less,
having a content of the functional food of 8% by mass or more and 40% by mass or less and a content of sucrose of less than 24% by mass with respect to the oil or fat based confectionery as a whole, and
containing no milk ingredient.

2. The oil or fat based confectionery according to claim 1, further comprising 25% by mass or more and 45% by mass or less of a saccharide having a sweetness of 0.8 or less when sucrose has a sweetness of 1.

3. The oil or fat based confectionery according to claim 1, wherein the functional food contains any one or more of coffee, green tea, black tea, wine, and black currant polyphenol.

4. The oil or fat based confectionery according to claim 3, wherein the functional food has
a blending amount of coffee of 15% by mass or more in a case of containing coffee,
a blending amount of green tea of 8% by mass or more in a case of containing green tea,
a blending amount of black tea of 15% by mass or more in a case of containing black tea,
a blending amount of wine of 9% by mass or more in a case of containing wine, or
a blending amount of black currant polyphenol of 6% by mass or more in a case of containing black currant polyphenol,
in terms of dry weight with respect to the oil or fat based confectionery as a whole.

5. The oil or fat based confectionery according to claim 1, wherein the oil or fat contains 35% by mass or more of one or more selected from cocoa butter and cocoa butter alternatives with respect to the oil or fat based confectionery as a whole.

6. A method for producing an oil or fat based confectionery comprising:
a step of mixing and grinding ingredients to obtain a base having a granularity of 30 μm or less,
wherein the ingredients include
a functional food containing a functional ingredient having at least one of bitterness and astringency; and
an oil or fat having a solid fat content (SFC) of 70% or more at 25° C. and a SFC of less than 15% at 35° C., and
the ingredients have a content of the functional food of 8% by mass or more and 40% by mass or less and a content of sucrose of less than 24% by mass with respect to the oil or fat based confectionery as a whole, and include no milk ingredient.
